(19) United States
(12) Patent Application Publication
(10) Pub. No.: US 2005/0043163 A1
(43) Pub. Date: Feb. 24, 2005

(54) Thermocycling device and rotor means therefor

(76) Inventors: Mats Malugvist, Gata (SE); Leif Andersson, Atvidaben (SE)

Correspondence Address: YOUNG & THOMPSON, 745 SOUTH 23RD STREET, 2ND FLOOR, ARLINGTON, VA, 22202, US

(21) Appl. No.: 10/481,571

(22) PCT Filed: Jun. 19, 2002
(86) PCT No.: PCT/SE02/01203

(30) Foreign Application Priority Data
Jun. 21, 2001 (SE) 0102219-3

(51) Int. Cl. B04B 15/02; B04B 5/02

(52) U.S. Cl. 494/14; 494/13; 494/16

(57) ABSTRACT

The invention relates to rotor means (5) for centrifuging reaction vessels containing samples in a thermocycling device. The rotor means (5) comprise/-s at least one fan blade (18) which force ambient gas to pass to samples. The intention also, relates to a thermocycling device for centrifuging reaction vessels containing samples comprising said rotor means (5).

The present invention relates to rotor means for centrifuging reaction vessels containing samples in a thermocycling device and a thermocycling device having such a rotor means.

### TECHNICAL BACKGROUND

The applicant has developed a method and an apparatus for rapid thermocycling of samples, i.e. to repeatedly subject the samples to heating and cooling while the samples are centrifuged. This method and apparatus is described in a previous patent application WO 00/58013 of the present applicant, incorporated herein by reference.

When using said apparatus, reaction vessels including the samples, i.e. the complete reaction mixture or a subset of this, are placed in a rotor of a centrifuge with the closed end directed downwards, outwards or otherwise according to standard practice for centrifuging the reaction vessels in question. The centrifuge is then started, i.e. the engine which brings the rotor to spin is switched on.

When the rotor has accelerated to the chosen gravitational force, the rotation is kept at constant speed. A heating source is now switched on leading to an increased temperature predominantly at the apices of the reaction vessels. The heat will be transferred through the material of the walls of the reaction vessels, to the most distal portion of the bulk of the samples. Alternatively, the heating acts directly on the samples contained in the reaction vessels.

Increased molecular motion due to increased temperature will expand the volume, that is, decrease the density of this heated part of the sample. Due to the forces caused by the gravitation acting on more dense subsets of the samples, the portions with lower density will be forced to move towards the opening end, immediately replaced by sample with higher density. This dense portion will then be heated by means of the same process of heat transfer from the heating source. The density of this portion of the sample will decrease and move towards the opening end and become replaced by cooler sample. In other words, the centrifugal forces render the heat convection much more effective.

Thereafter a cooling of the samples in the reaction vessels will take place. The heating source is switched off and the reaction vessels are made accessible to the flow of air or gas, caused by the rotation and/or a cooling gas is supplied to the centrifuge.

During the cooling of the reaction vessels, the heat in the walls of the vessels will decrease and the portion of the sample closest to the wall will cool down and become more dense, whereby the cooled sample portion will move towards the closed end, i.e. in the direction of the gravitational force, sliding along the walls, whereby a new portion of the sample will be cooled in the vicinity of the walls. Again, the centrifugal forces increase the effectiveness of convection.

In thermocycling processes, for example polymerase chain reactions (PCR), the heating and cooling phases are repeated several times. Of course this take a lot of time, although the apparatus and method of WO 00/58013 has tremendously decreased the process time. Still there is a need of shortening the process time, in particular the transition time between the different process temperatures.

### SUMMARY OF THE INVENTION

Accurate and fast cooling of the samples is important in thermocycling processes. In particular in PCR, it is known that no productive activity occurs in the samples during the cooling phase of the process. Therefore the cooling time should be decreased to a minimum. This insight forms one of the basis of the present invention.

The solution to the problem of decreasing the cooling time is provided by novel rotor means having the features according to claim 1 and by a novel a thermocycling device having rotor means according to the present invention.

By the provision of at least one fan blade in the rotor means, ambient gas is forced to pass the samples, whereby, for example, a more effective cooling of the samples may be performed since a larger amount of ambient gas will pass the samples than if the samples would only be, subjected to the ambient gas by its rotational speed. The function of the fan blade-/s may be compared with the function of a centrifugal pump.

In order to effectively perform the cooling of the samples, the ambient gas could be conducted through a conducting passage.

According to a preferred embodiment the rotor means comprises a base portion and a lid portion, forming an inner space between these two portions. Within this inner space the fan blade-/s are provided.

Preferably the lower portion of the rotor means, for example but not necessarily the base portion, is provided with at least one through hole to let the gas into the inner space, or more precisely, the gas will be drawn into the inner space by the performance of the rotating fan blade-/s in the inner space. Preferably the upper portion of the rotor means, for example the lid portion but not necessarily, is provided with at least one through hole to let the gas, which is drawn in and forced through the inner space, out of the inner space.

The fan blade-/s may for example be arranged on the inside, i.e. the side that faces the inner space, of the lid portion or on the inside of the base portion.

In order to increase the throughput of the device and/or process, it would be an advantage to be able to handle more samples at the same time. One way of doing this is to handle samples arranged in a parallel format, for example in at least one microtitre plate. Microtitre plates are available in different formats, such as the traditional 96 well format, and e.g. the more dense 384 well format, as well as the 1536 well format.

Using microtitreplates, the benefits of the invention become accentuated. If only the airflow caused by the rotation velocity is used to cool the reaction vessels containing the samples, a problem of non-uniform cooling of the samples will appear. The airflow will hit the row of reaction vessels in the front, in relation to the travelling direction of the microtitre plate, whereafter, due to natural flow, the airflow will be diverted outside the closed ends of the reaction vessels of the microtitre plate towards the back of the plate.

Thanks to the present invention it becomes possible to cool all the samples in the microtitre plate by forcing ambient gas to pass in between the wells containing the samples by means of at least one fan blade and at least one gas conducting passage provided in the rotor means.

The gas may be ambient air or any gas supplied to the rotor means and its surroundings. The air or gas may be cooled by cooling means.

Another problem that arises when centrifuging microtitre plates is that there will be a chord difference between the side edges and the centre in comparison with heating means, e.g. IR sources, provided adjacent outside the rotor means so that the samples arranged closer to the side edges will be closer to the heating means, and thereby more heated, than the samples closer to the centre.

According to the present invention this problem is solved by providing a screen with lateral density differences towards the centre between the heating means and the samples, arranged at the rotor means, for compensating of the chord differences.

Yet another problem that arises in particular when reaction vessels in the parallel format, e.g. microtitre plates, are used is that of deformation of the reaction vessels. Under the high centrifugal forces and elevated temperatures, the microtitreplates are frequently deformed. According to conventional techniques, this is avoided by the provision of supporting elements shaped as a negative print of the microtitreplate. In other words, the microtitreplate is placed in a solid support having wells corresponding to each reaction vessel or well of the microtitreplate. Due to this arrangement, the reaction vessels or wells are not accessible for analysis, nor for effective heating and cooling.

The arrangement according to the present invention provides a highly beneficial solution to the problem of microtitreplate deformation. The base portion of the rotor which together with the lid portion define an inner space through which ambient air is forced, does simultaneously constitute a support for the microtitreplates without obstructing the airflow and thus allowing for efficient cooling. By providing a transparent base plate, the reaction vessels are available for analysis if desired. Optionally, the base plate may be provided with indentations corresponding to the apices of the reaction vessels.

It should be noted that the function of the rotor means according to the present invention may be advantageous not only during cooling but also during keeping of temperature in and heating the samples.

### SHORT DESCRIPTION OF THE DRAWINGS

The present invention will be described by way of exemplifying embodiments in connection with the appended drawings.

FIG. 1 illustrates in a perspective view an inner portion of a thermocycling device for centrifuging samples according to a preferred embodiment of the present invention.

FIG. 2 illustrates in an exploded diagram rotor means according to a preferred embodiment of the present invention.

FIG. 3 illustrates a screen provided in the rotor means.

FIG. 4 illustrates in a view from underneath a portion of the rotor means having fan blades.

FIG. 5 illustrates in a cross section view the rotor means of the present invention.

FIG. 6 illustrates a close up view of the rotor of FIG. 5 with a microtitre plate mounted.

FIG. 7 illustrates in a cross section view a thermocycling device according to a preferred embodiment of the present invention provided with cooling means. It also illustrates the flow of the gas during a cooling phase.

FIG. 8 illustrates the device in FIG. 7 and the flow of the gas during a temperature keeping phase.

FIG. 9 illustrates the device in FIG. 7 and the flow of the gas during a heating phase.

### DETAILED DESCRIPTION OF PREFERRED EMBODIMENTS

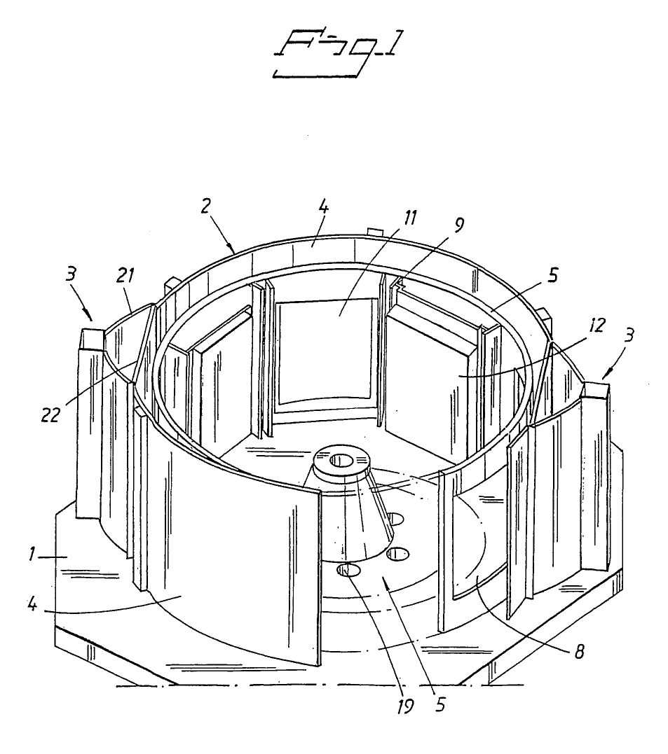

FIG. 1 illustrates an inner portion a preferred embodiment of a thermocycling device provided with rotor means according to the present invention. It comprises a bottom plate 1 and a substantially cylindrical wall 2 made up by heating means portions 3 and, if desired, wall portions 4. In this embodiment the cylindrical wall 2 is made up by two heating means portions 3, arranged opposite each other, and four wall portions 4. Of course it is possible to have any other combination, for example, four heating means portions 3 and four wall portions 4.

Within the cylindrical wall 2 rotor means 5 (only partially shown in FIG. 1) is rotatably mounted in the centre by means of some kind of bearing and is for example connected to rotating means (not shown), such as a motor, preferably provided underneath the bottom plate 1.

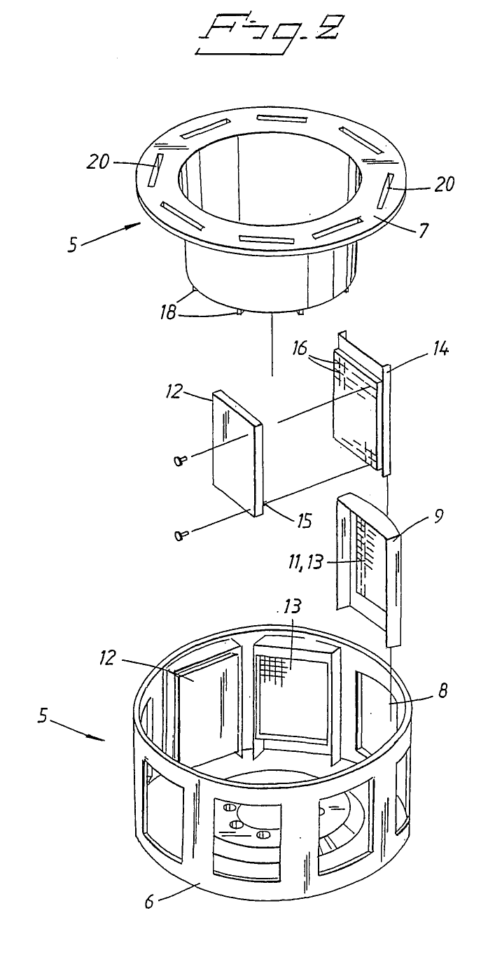

In FIG. 2 the rotor means 5 and parts to be placed therein are shown in an exploded view. The rotor means 5 comprises a base portion 6 and a lid portion 7. The base portion 6 is provided with side recesses 8 and in connection with each side recess 8 a guide portion 9 is mounted.

The guide portion 9 is also provided with a side recess 10, which is covered by a plate 11 of glass or another heat transferable material. In, on or adjacent the plate 11 a screen 13 of for example aluminium is provided, which has different density laterally towards its centre to compensate for the chord difference between the sides and the centre of a microtitre plate 12 arranged in a guide portion 9 to the heating means arranged in the heating means portion 3. One way of obtaining this density difference in the screen 13 is to have gradually larger holes in the screen 13 towards the centre, see FIG. 3.

The above mentioned microtitre plate 12, comprising samples, is mounted in a cassette 14, preferably with the wells 15 of the microtitre plates 12 protruding through adapted holes 16 in the cassette 14. The cassettes 14 may be adapted for different kinds of microtitre plates 12 or different cassettes 14 may be provided for different kinds of microtitre plates 12 but all the cassettes 14 are adapted to fit into the guide portions 9. The closed ends of the wells 15 of the microtitre plates 12 may rest against the plate 11 in the guide portion 9, at least during centrifuging.

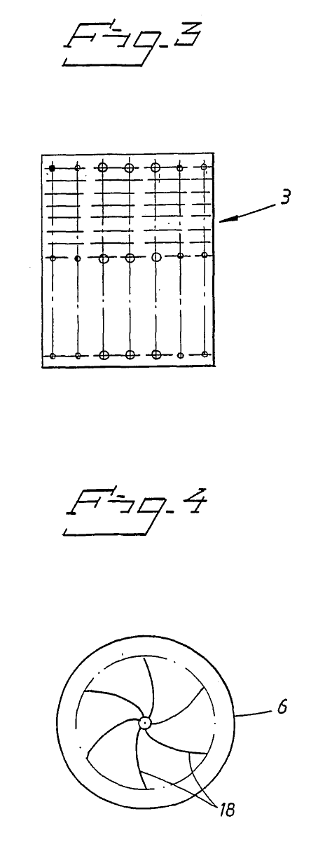

The lid portion 7 is mounted on top of the base portion 6. Thus, an inner space 17 is formed between the base portion 6 with its mounted guide portions 9 and the lid portion 7, see FIG. 4. In the preferred embodiment fan blades 18 are arranged at the bottom of the lid portion 7 at the side which faces the inner space 17.

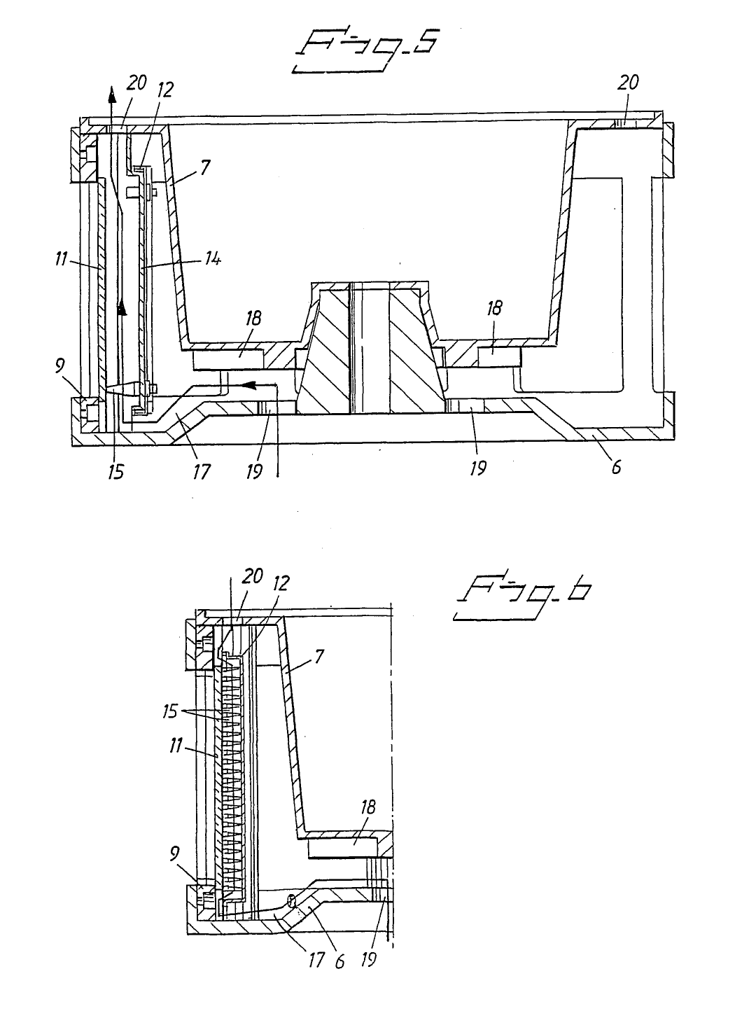

The fan blades 18 will have the same kind of function as a centrifugal pump when the rotor means 5, and thereby the fan blades 18, rotate. The fan blades 18 are preferably arranged so that when they rotate they draw ambient gas into the inner space 17 through holes 19 arranged in the base portion 6, see arrows in FIG. 5, and force the ambient gas through the inner space 17 and out of holes 20 in the lid portion 7.

The holes 16 in the lower portion of the rotor means 5 are preferably arranged close to the rotational centre and the holes 20 in the upper portion of the rotor means 5 are preferably arranged along the cassettes 14, on the outsides thereof.

Since the only way out for the forced flow of gas is through the holes 20 and the fact that the cassettes 14 are in close contact with the lid portion 7 the gas will be forced underneath the cassettes 14 and in between the wells 15 of the microtitre plates 12, which wells 15 are positioned between the plates 11 covering the side recesses 10 of the base portion 6 and the cassettes 14, and up and out of the holes 20. This is shown by arrows both in FIG. 5 and FIG. 6. In other words, a conducting passage is provided to conduct the forced flow of gas to pass the samples.

It is conceivable to provide baffles (not shown) in front of the lowest row of wells 15 of the microtitre plate 12 to disturb the forced gas flow so that this row will not directly be hit by the gas flow, which is forced to pass underneath the cassette 14.

If the microtitre plates 12 are provided with upper and lower side edges that could obstruct the gas flow between the wells 15 thereof, these upper and lower side edges will be fully or partially removed. The direction is related to the position when mounted in the rotor means 5.

In the preferred embodiment the samples is heated by IR-light but it is conceivable to heat with hot gas, for example. The heating means portions 3 comprises a reflector 21, the IR-light therein (not shown) and a glass plate 22 arranged in guide slots in the reflector 21. The glass plate 22 gives a flat surface, which is easy to clean.

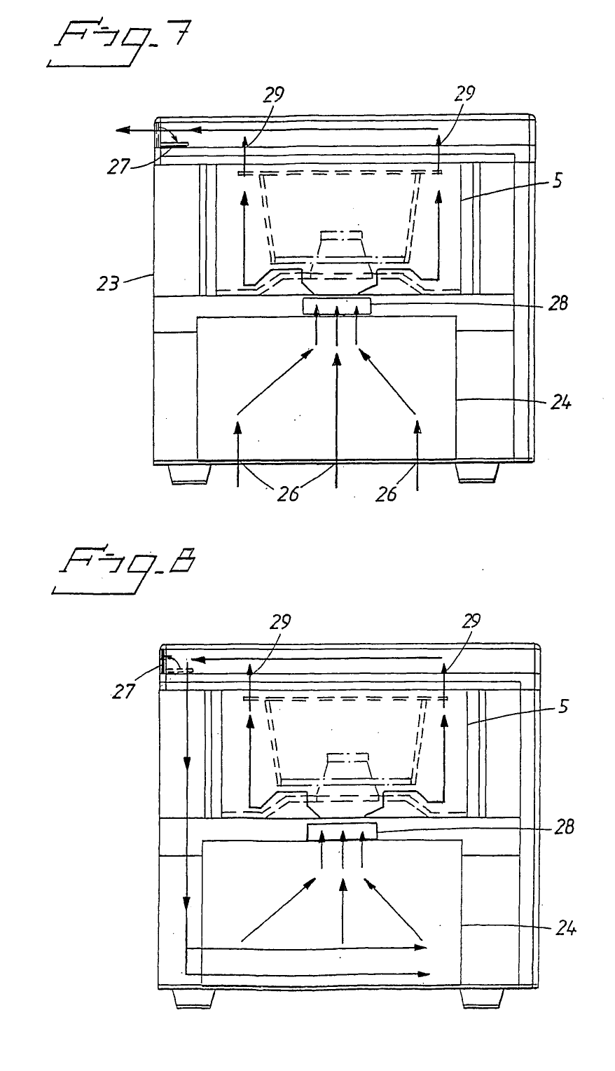

Outside of the substantially cylindrical wall 2 a burst wall is provided for safety reasons, and having insulation provided there between. In FIG. 7 an embodiment of the thermocycling device according to the present invention is illustrated, which is provided with cooling means 24. The burst wall, cylindrical wall 2 and the rotor means 5 are provided in the upper portion of a box like housing 23, which comprises an openable lid 25. The lid 25 is preferably sealed along its outer rim. For ensample the cooling means 24 may be a compressor cooling arrangement.

Gas canals and valves are provided in the housing 23, see the arrows showing the flow through the housing 23 during a cooling phase in the process in FIG. 7. In the bottom of the cooling means 24 at least one inlet valve 26 is provided that in open position take in ambient air to be cooled by the cooling means 24. In the lid 25 at least one outlet valve 27 and at least one transfer valve 29 is provided. The transfer valve 29 leads into an outlet canal in the lid, which leads to the outlet valve 27.

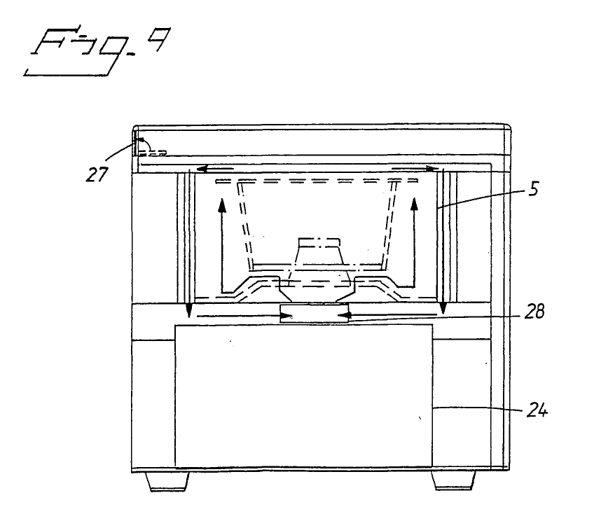

When the outlet valve is open the cooling gas, in this embodiment ambient air, may leave the housing 23 and at the same time a recycling canal is closed by the outlet valve 27. During a temperature keeping phase of the process, see FIG. 8, the outlet valve 27 is closed and the gas cannot leave the housing 23 but instead the recycling canal is open so that the gas can be recycled into the cooling means 24. The inlet valve 26 is then closed.

Between the cooling means 24 and the rotor means 5 a centre valve 28 is provided. During the two above mentioned process phases the centre valve 28 is open to let gas into the rotor means 5 from the cooling means 24.

In FIG. 9 the heating phase of the process is illustrated. The inlet valve 26 and the centre valve 28 is closed in such a way that no gas can pass from the cooling means 24 to the rotor means 5. Also the transfer valves 29 in the lid are closed so that the gas will pass outside of the rotor means 5 down to the centre valve 28 underneath the rotor means 5. The gas will pass through the centre valve 28 from its sides and into the rotor means 5 again.

1. Rotor means for centrifuging reaction vessels containing samples in a thermocycling device, characterised in that the rotor means (5) are adapted for centrifuging samples arranged in at least one microtitre plate (12) and comprise/-s at least one fan blade (18), which force ambient gas to pass the samples.

2. Rotor means according to claim 1, wherein at least one gas conducting passage (17) is arranged in the rotor means (5) to conduct the gas to pass the samples.

3. Rotor means according to claim 1, wherein the rotor means (5) comprise/-s a base portion (6) and a lid portion (7), in between which an inner space (17) is formed wherein the fan blade/-s (18) are arranged.

4. Rotor means according to claim 1, wherein the lower region of the rotor means (5) is provided with at least one through hole (19) through which the gas may be drawn.

5. Rotor means according to claim 1, wherein the upper region of the rotor means (5) is provided with at least one through hole (20) through which the gas is let out.

6. Rotor means according to claim 3, wherein the fan blade/-s (18) are arranged at the inside of the base portion (6) of the rotor means (5).

7. Rotor means according to claim 3, wherein the fan blade/-s (18) are arranged at the inside of the lid portion (7) of the rotor means (5).

8. Rotor means according to claim 2, wherein the at least one gas conducting passage is arranged to conduct the gas between the sample-containing wells (15) of the microtitre plate (12).

9. Rotor means according to claim 1, wherein a screen (13) with lateral density differences towards the centre is arranged at the rotor means (5) between the samples and heating means (3) outside of the rotor means (5), for compensating of chord differences in the microtitre plate (12).

10. Rotor means according to claim 1, wherein a plate (11) pervious to IR radiation, is arranged to support the at least one microtitre plate.

11. Rotor means according to claim 10, wherein the plate (11) has indentations corresponding to the apices of the wells of the microtitreplate.

12. Rotor means according to claim 1, wherein the gas is ambient air.

13. Rotor means according to claim 1, wherein cooling means (24) is provided to cool the ambient gas.

14. Thermocycling device for centrifuging reaction vessels containing samples, characterised in that it comprises rotor means (5) according to claim 1.
